(19) United States
(12) Patent Application Publication
(10) Pub. No.: US 2026/0137168 A1
(43) Pub. Date: May 21, 2026

(54) TRACTION LUG FOR FOOTWEAR

(71) Applicant: VIBRAM S.P.A., Albizzate (Varese) (IT)

(72) Inventors: Marco BRAMANI, Milano (IT); Steven Ellis, Baldwinville, MA (US); David FILAR, Worcester, MA (US); Sophia Luo, Guangdong (CN); Tony GIN, Guangdong (CN)

(21) Appl. No.: 19/400,472

(22) Filed: Nov. 25, 2025

Related U.S. Application Data
(63) Continuation-in-part of application No. 19/250,711, filed on Jun. 26, 2025.
Application No. 19/250,711 is a continuation-in-part of application No. 17/611,455, now Pat. No. 12,364,313.

(30) Foreign Application Priority Data
May 14, 2019 (IT) 102019000006827

(51) Int. Cl. A43B 13/22; B29C 33/38; B29L 31/50; B33Y 80/00

(52) U.S. Cl. CPC A43B 13/22; B29C 33/3842; B33Y 80/00; B29K 2905/00; B29L 2031/504

(57) ABSTRACT

A lug for a sole or outsole of a footwear, i.e. a shoe or a boot, which is able to improve the traction or grip features of the sole itself; sole or outsole equipped with a plurality of lugs and a method for obtaining a mold cast printed with a 3D printing machine to obtain the sole and/or the lugs.

### TECHNICAL FIELD OF INVENTION

The present invention relates to a lug for a sole or outsole of a footwear, i.e. a shoe, a sport shoe or a boot. In particular, the present invention relates to a lug showing improved traction or grip features.

The present invention relates also to a sole or outsole equipped with at least one and/or a plurality of lugs according to the present invention.

Furthermore, such lugs are obtained with a mold made by casting around a 3D printed part.

### DESCRIPTION OF RELATED ART

The technique of three-dimensional printing, also known as “additive manufacturing”, is experiencing a great development in last years. In general, with this technique it is possible to produce a three-dimensional object, also with complex structures, starting from a three-dimensional “file” generated by appropriate software and arriving to the production, for example by means of successive layers, of a complete three-dimensional object.

This construction technique allows the production of structures of any geometric complexity, by the addition of a material which has the needed or desired characteristics. This simultaneously allows an elevated freedom of design/construction and the possibility of reducing waste material.

In the footwear sector, more particularly in the field of sport, running, outdoor, or work and safety footwear, the problem to have a product that is well suited to the different features of the foot and of the movement of the user, in relation to the specific activity to be performed, is particularly felt.

In particular, an always greater need, in the footwear sector, is to have a sole or outsole with improved grip and traction, also on sliding or slippery or granular grounds.

The most common technique to produce soles or outsoles of footwear is that of traditional molding of elastomeric material.

Further, to date, a sole is produced by molding, gluing or combining different components such as tread, midsole of different density, and any further elements, such as lugs or cleats. Such different components, previously obtained in specific molds, are then assembled by gluing or co-molding, thus requiring a large number of involved machines.

The patent application US2016/198793A discloses a running shoe which includes an upper coupled to a sole structure. The sole structure includes a compressible midsole and an outsole. The outer surface of the outsole includes a series of treads or traction elements extending along the bottom and sides of the outsole. With this configuration, when the sole structure contacts an uneven surface, the outsole conforms around it, stabilizing the footwear during use.

The patent application US2005/081405A1 discloses a shoe outsole containing articulated lugs of various shapes extending downward from the base of the outsole and adapted for contacting the ground and enhancing traction.

The patent application US2007/283595A1 discloses a sole for footwear with a plurality of x-shaped pillars, preferably made of rubber or another elastomer. The x-shaped pillars are vertical columns in the cross-sectional shape of an “X” having a wider base towards the inside of the footwear and extending, preferable in steps, to a narrower cross-section at the walking surface.

The patent application US2014/026441A1 discloses a footwear, especially football shoes, which includes a sole structure including a sole component and at least a first ground engaging member extending substantially downward from the bottom surface of the sole and having a substantially circular cross-sectional shape. In addition, the sole structure may also include a tapered support structure which has a substantially pyramidal shape and partially surrounds the first ground engaging member such that a portion of the first ground engaging member is exposed between edges of the tapered support structure.

The patent US3413737A discloses a cleat for a football shoe comprising a base portion for attachment to the sole and a generally frusto-conical portion unitary with the base portion and converging downwardly therefrom. The surface of the generally frusto-conical portion has a plurality of serrations encircling the periphery of such generally frusto-conical portion. Furthermore, notches or grooves are present, which are spaced circumferentially around an edge of the generally frusto-conical portion.

There is therefore a need to produce a sole or outsole for footwear, and in particular, a lug for a sole or outsole, able to respond to the above requirements, while allowing high traction while performing athletic activity, for example walking or running or the like, for which they are provided.

### SUMMARY OF THE INVENTION

The main aim, therefore, of the present invention is to improve the state of the art in the field of soles or outsoles for footwear through the production of at least a lug that has the ability to improve grip or traction also on terrains consisting of granular particulates or penetrable surfaces.

Another advantage of the present invention is that to provide a lug that is customizable and/or customized on the base of specific data and needs, as a result of previous measurements.

Yet another objective of this invention is to provide a sole or outsole for footwear equipped with a plurality of lugs for improving grip or traction also on terrains consisting of granular particulates or penetrable surfaces.

A further aim of the present invention is to provide a mold for a sole or outsole and/or for at least one lug for a sole or outsole for footwear that is fast and easy to produce at competitive costs.

According to a first aspect of the present invention, a lug for a sole or outsole of a footwear, i.e. a sport shoe, a shoe or a boot, is provided according to the present application.

According to a further aspect of the present invention, a sole or outsole comprising at least a lug is provided according to the present application.

A further objective of the present invention is moreover that of providing a method for obtaining a mold for producing a sole or outsole and/or at least one lug according to the present invention and a method for obtaining such sole or outsole.

Further advantages or preferred characteristics of the invention are described in the present application.

### BRIEF DESCRIPTION OF THE DRAWINGS

Other features and advantages of the present invention will be more apparent from the description of an embodiment of a lug for a sole or outsole for footwear, illustrated by way of example and not limited to the accompanying drawings, in which:

FIG. 1 is a perspective view of one version of a lug for a sole or outsole of footwear used as control lug during test;

FIGS. 2A-2C show in top plan view, together with its longitudinal and transversal sections (the longitudinal direction goes from toes to heel of a respective sole or outsole while the transversal direction goes from side to side) of another version of a lug for a sole or outsole of footwear used as control lug during test;

FIGS. 3A-3C show in top plan view a version of a lug for a sole or outsole of footwear according to the present invention, together with its longitudinal and transversal sections (the longitudinal direction goes from toes to heel of a respective sole or outsole while the transversal direction goes from side to side);

FIGS. 4A-4C show in top plan view another version of a lug for a sole or outsole of footwear according to the present invention, together with its longitudinal and transversal sections (the longitudinal direction goes from toes to heel of a respective sole or outsole while the transversal direction goes from side to side);

FIG. 5 is a bottom view of a sole with a plurality of lugs of FIGS. 2A-2C for test control;

FIG. 6 is a bottom view of a sole with a plurality of lugs of FIG. 1 for test control;

FIG. 7 is a bottom view of a sole with a plurality of lugs of FIGS. 9A-9C;

FIGS. 8A-8C show in top plan view the lug of FIG. 1, together with its transversal and longitudinal sections (the longitudinal direction goes from toes to heel of a respective sole or outsole while the transversal direction goes from side to side);

FIGS. 9A-9C show in top plan view another version of a lug for a sole or outsole of footwear according to the present invention, together with its transversal and longitudinal sections (the longitudinal direction goes from toes to heel of a respective sole or outsole while the transversal direction goes from side to side);

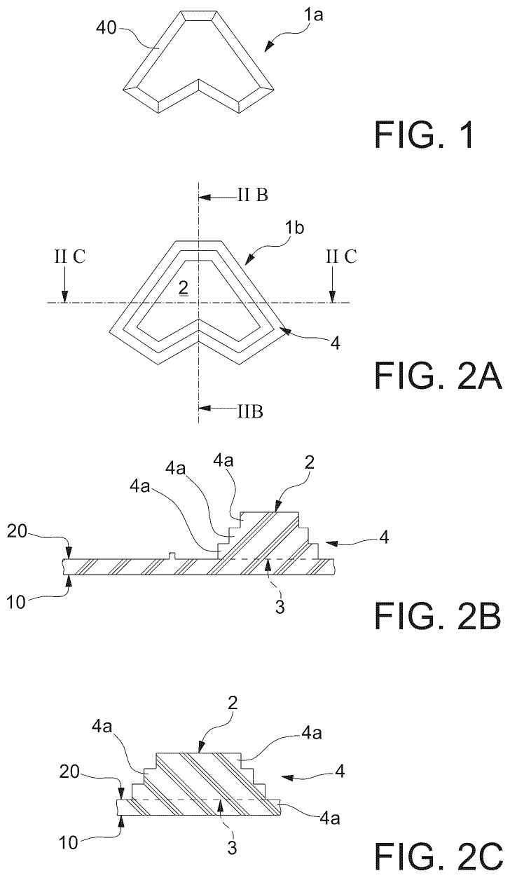

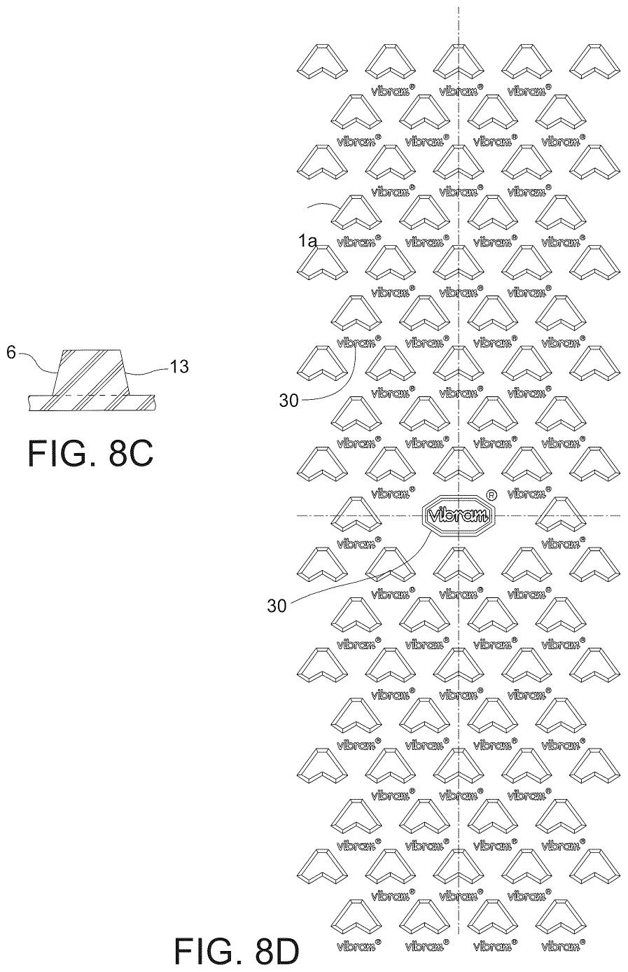

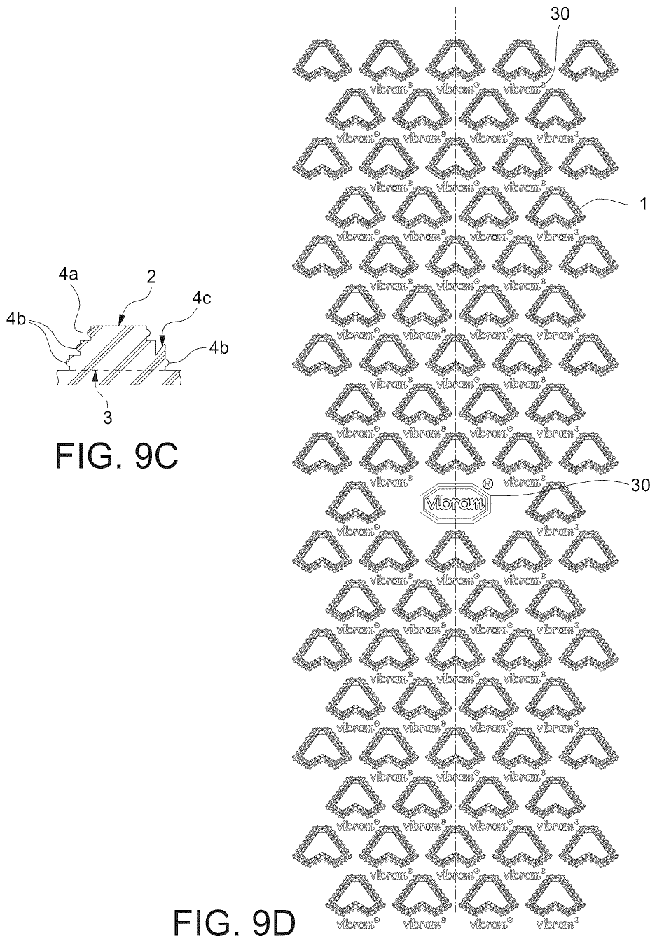

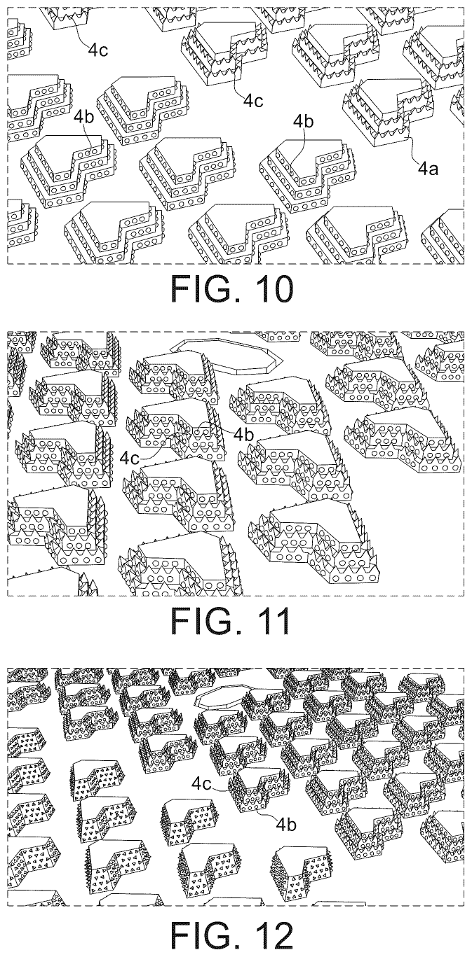

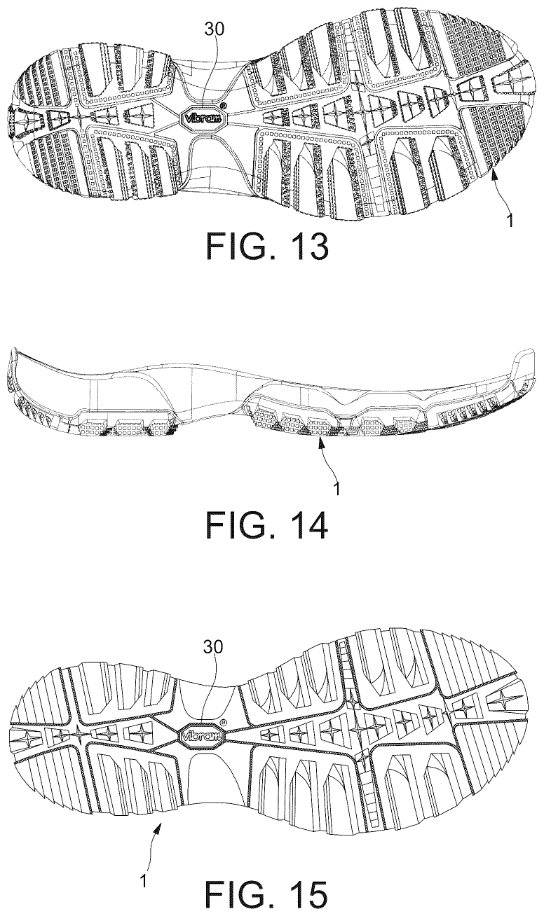

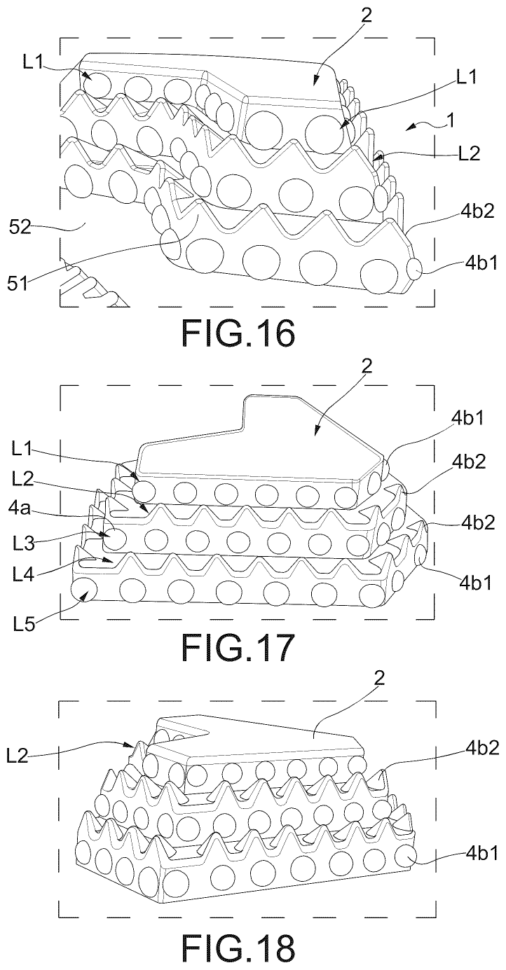

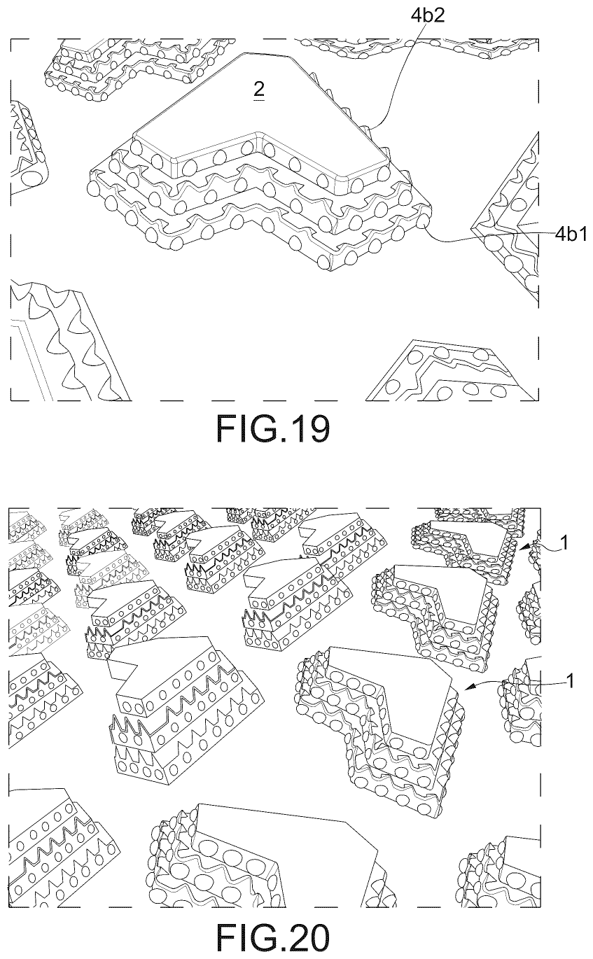

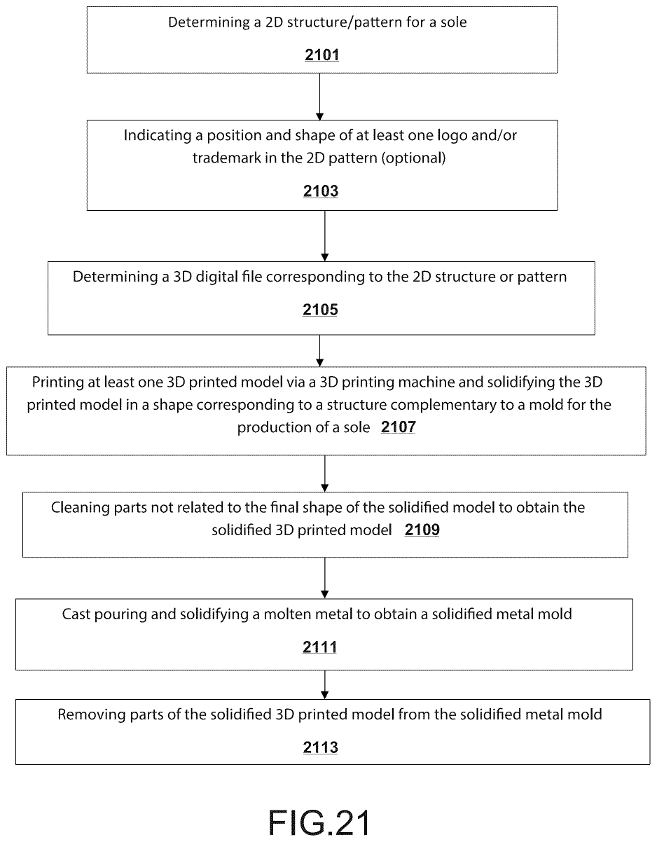

FIGS. 8D, 9D show the pattern of a sole or outsole equipped respectively with a plurality of lugs of FIG. 1 or 9A-9C;

FIGS. 10, 11 and 12 illustrate various possible steps of production of a mold for obtaining the sole and/or the at least one lug of the present invention;

FIGS. 13 and 14 show a bottom view and a lateral view of an example of the present invention;

FIG. 15 shows another example of the present invention;

FIG. 16 shows a perspective side view of the lug depicted in FIG. 11 or of a lug according to a version of the present invention;

FIG. 17 shows another perspective side view of the lug of FIG. 16;

FIG. 18 shows another perspective side view of the lug of FIG. 16;

FIG. 19 shows a perspective top view of the lug of FIG. 16;

FIG. 20 shows a perspective view of a sole having lugs according to FIG. 16; and

FIG. 21 depicts an exemplary method for obtaining a mold for the production of a sole according to an embodiment of the present invention.

### DETAILED DESCRIPTION OF THE INVENTION

With reference to the attached figures, the reference number 1 generally indicates a lug for a sole or outsole of a footwear, i.e. shoe a sport shoe or a boot or an outdoor shoe or a work or safety footwear, according to the present invention.

The at least one lug 1 and/or the plurality of lugs 1 of the present invention are disposed on the bottom of the sole creating the treat of the sole or outsole.

The lug 1 and the sole and/or outsole equipped with a plurality of lugs 1 according to the present invention have an improved grip or traction on terrains consisting of granular particulates or penetrable surfaces such as sand, gravel, mulch, dirt, snow, etc.

Therefore, thanks to the lugs of the present invention, the sole or outsole is able to provide stability to the user, according to the athletic activity or movement that the user intends to perform wearing the specific footwear equipped with such sole or outsole.

In the following specification, the word “sole” can be used alone, always meaning sole or outsole of a footwear.

Furthermore, with “low” or “lower” it is meant an object or component facing or positioned toward the support surface or the ground, with “upper” or “higher” it is meant an object or component facing or positioned toward the user, with “lateral” it is meant an object or component facing or positioned medially or laterally relative to the user's foot.

Further, with “front” or “frontal” it is meant an object or component facing or placed at the toes of the foot of a user while with “rear” or “posterior” it is meant an object or component facing or placed at the heel of the foot of a user.

The sole according to the present invention presents a thickness and an extension, according to a top plan view, substantially corresponding to that of the soles of the traditional type or slightly greater than that of the user's foot.

The sole according to the present invention comprises an upper surface 10, adapted in use to face toward the foot of a user, and a lower surface 20, adapted in use to face toward the resting surface or the ground.

The upper surface 10 may be suitable to contact an upper and/or an inner sole or midsole.

The lower surface 20 is equipped with at least one and/or a plurality of lugs 1 according to the present invention.

In particular, in at least one version of the present invention, the lower surface 20 is directly attached, for example by means of a unique molding step, with at least one lug 1.

The lug 1 comprises a first base 2, a second base 3 and a sidewall 4.

In particular, the first base 2 is lower in use, i.e. it is suitable to contact the ground while the second base 3 is upper in use, i.e. it is stably attached to the lower surface 20 of the sole.

The second base 3 is opposite to the first base 2 and the sidewall 4 connects laterally the first base 2 and the second base 3 and/or the lower surface 20 of the sole.

One peculiarity of the present invention is that at least a part of the sidewall 4 of the present invention has lateral features and/or elements on it, which are very small (compared to the entire sidewall 4 of the lug) and obtained as better explained below. These lateral features and/or elements are able to confer to the lug 1 and/or to the sole a better traction when compared to lugs with smooth sidewall (as the sidewall 40 shown in FIGS. 1 and 8A-8C).

In fact, such lateral features and/or elements increase significantly the surface area of the sidewall 4, thus conferring better traction and/or grip, for example on terrains consisting of granular particulates or penetrable surfaces.

In a version of the invention, the features and/or elements are present also at the first base 2, increasing the surface area of the first base 2.

The thickness of the sole can be variable. For example, the thickness of the sole at the part in use in the front of the sole can be smaller than the thickness of the sole at the part in use in the rear of the sole.

In the same way, the height (i.e. the distance between the first base 2 and the second base 3) of the lugs can be variable along the sole or also between the front part of the lug and its rear part. For example, the height of the lug/s 1 can be smaller at the part in use in the front of the sole while it can be greater at the part in use in the rear of the sole.

In another version of the invention, the thickness of the sole and/or the height of the lugs 1 can be the same both at the front and at the rear part of the sole itself.

Furthermore, the overall configuration of the lugs 1 can be variable according to the specific position of the lug itself according to the sole, or it can be the same all along the entire sole.

According to a specific version of the present invention, for example shown in the attached FIGS. 1-12, the lug 1 has a V-like shape in top plan view. In such a case, the first base 2 and said second base 3 have a V-like shape in top plan view.

However, the lug 1 can have also a different three-dimensional shape, such as in general a substantially cylindrical, hemispherical, tetrahedral, semi-ellipsoidal, prismatic, cubic, parallelepiped, frustum of cone or frustum of pyramid, regular, irregular, L-like, C-like shape, and so on. In this case, the first base 2 and the second base 3 have a square, rectangular, polygonal, parallelogram, regular, irregular, L-like, C-like or trapezoidal shape, etc.

In a particular embodiment of the invention, as shown in the attached FIGS. 1-12, the first base 2 is smaller in size than the second base 3. According to this, the sidewall 4 is inclined and/or tapered, for example towards a common point. Therefore, the faces constituting the sidewall 4 of the lug are inclined along directions converging towards the ground.

In another version of the invention, the first base 2 and the second base 3 can have the same size, but they can be offset the one with the other. According to this, the sidewall 4 is still inclined. In this way, however, all the faces constituting the sidewall of the lug 1 are inclined along the same direction. This direction is the direction of offset of the first base 2 and second base 3.

In another version of the invention, the first base 2 and the second base 3 have the same size, and they are substantially superimposed the one with the other. According to this, the sidewall 4 is substantially perpendicular to the first base 2 and/or to the second base 3. In this way, therefore, all the faces constituting the sidewall of the lug 1 have the same direction and/or are substantially vertical.

According to another option, the lug 1 comprises at least one planar side or a planar portion of the sidewall 4, or at least one flat side or a flat portion of the sidewall 4.

In an example shown in FIGS. 2A-2C, the sidewall 4 of the lug 1b is stepwise. This can be a test control lug or the base-shape for the lugs of the present invention. In this example, the sidewall 4 comprises at least one step 4a or at least two steps 4a, three in the illustrated version.

Each step 4a has substantially the same size and/or it has sharped or rounded edges and/or it has right-angled edges.

In another version of the invention, the sidewall 4 is not stepwise or has not a step or is smooth.

In a version of the invention, the sidewall 4 and/or the step 4a has a plurality of protrusions 4b, for example lateral protrusions 4b.

With the stepped lug, it is possible to have more features and/or elements. In any case, it is not necessary that the lug 1 has a stepped structure.

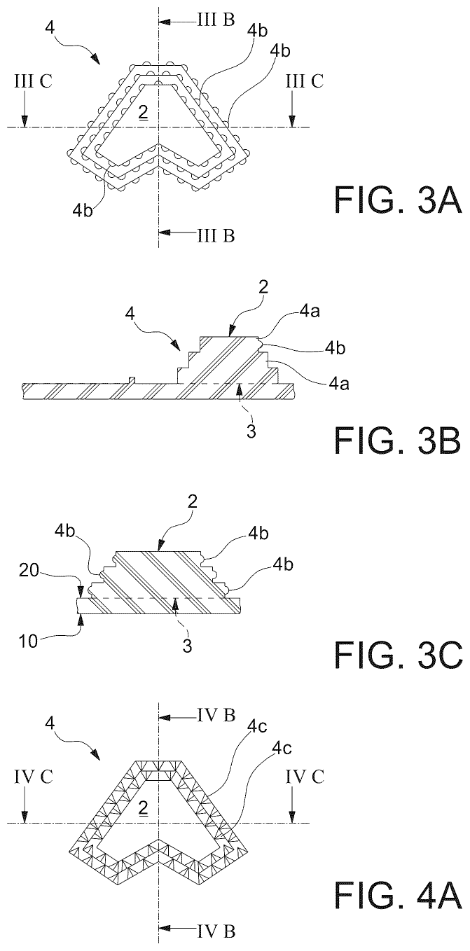

In the FIGS. 3A-3C, such lateral protrusions 4b have a protruding shape and a base, wherein the protruding shape is a substantially semispherical shape. The base of each protrusion 4b is attached to the sidewall 4 and/or on the vertical side (i.e. the side extending substantially along a direction going from the foot to the ground) of the step 4a.

The lateral protrusions 4b can have the protruding shape as a faceted semi-sphere. Otherwise, the protruding shape of the protrusions 4b can have a pyramidal, frustum of pyramid, frustum of cone, conical, or prismatic shape and so on.

According to another version, the lateral protrusions 4b can also be present on the first base 2 of the lug 1 and/or on the horizontal sides of the steps 4a.

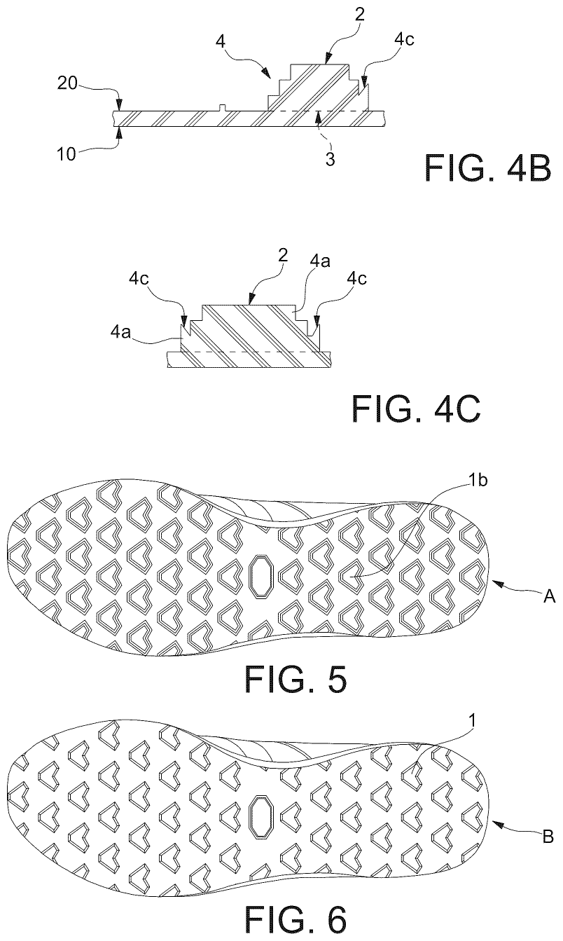

In a second version of the invention, for example shown in FIGS. 4A-4C, the sidewall 4 of the lug 1 is stepwise. In this version too, the sidewall 4 comprises several steps 4a, three in the illustrated version.

Each step 4a has substantially the same features as disclosed for the previous versions. In such a version of the invention, the sidewall 4 and/or the step 4a comprises a plurality of indentations 4c. Each indentation 4c comprises an intruding shape and a base, wherein the base is placed at the sidewall 4 and/or at the step 4a.

The intruding shape can have a substantially semispherical shape or a faceted semi-sphere, or pyramidal, frustum of pyramid, frustum of cone, conical, or prismatic shape. In the figures, the indentations 4c have a spike or pyramidal or diamond shape. In a version of the invention, both protrusions 4b and indentations 4c are present, such as for example in FIGS. 9A-9C.

In such a version, the indentations 4c have a semispherical shape while the lateral protrusions 4b have a pyramidal or diamond shape, a parallelepiped or rectangular prism shape, or any further suitable shape.

Otherwise, the lateral protrusions 4b have a semispherical shape while the indentations 4c have a pyramidal or diamond shape, a parallelepiped or rectangular prism shape, or any further suitable shape.

As shown in FIG. 4C, the base of each indentation 4c is placed at the horizontal side of the step 4a, extending inside the step 4a and/or the sidewall 4, along a substantially vertical direction. The apex of the indentation 4c is inside the lug 1.

In this case too, the indentations 4c could be placed at the first base 2 of the lug 1 and/or on the vertical sides of the steps 4a.

In this particular version, the presence of the indentation 4c can create, in at least one step 4a, the fact that it has no more a right-angled edge: it acquires a spike edge, with a sort of tip or sharped edge at the top portion thereof.

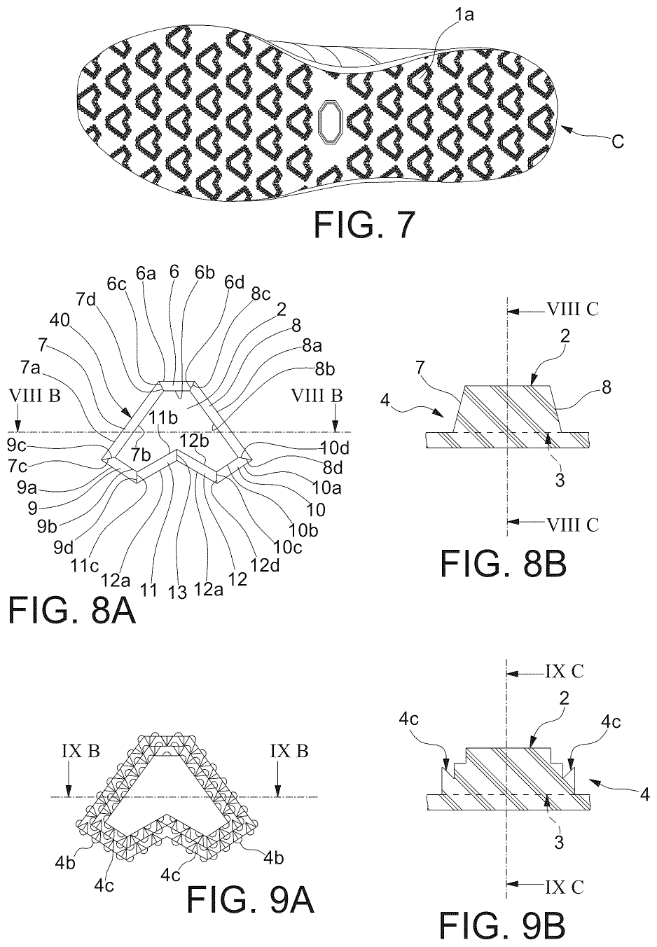

FIG. 5 shows a sole or outsole A equipped with a plurality of lugs 1b, according to the version shown in FIG. 2A; FIG. 6 shows a sole or outsole B equipped with a plurality of lugs 1a, according to the version shown in FIG. 1; FIG. 7 shows a sole or outsole C equipped with a plurality of lugs 1, according to the version shown in FIG. 9A.

In FIGS. 1 and 8A-8C, it is disclosed the structure of the lug 1a which has a substantially V-like shape in top plan view.

Such structure can be applied also to the lug 1, when it has a V-like shape.

In such lug 1a—as disclosed before for the lug 1—we can identify a first base 2 smaller than a second base 3, the latter being attached to the lower surface 20 of the sole. As the first base 2 is parallel to the second base 3, and centrally symmetrically placed with respect to the second base 3, the sidewall 4 of the lug is uniformly inclined towards the inner of the lug itself.

Looking from the front to the rear or heel of the sole, the sidewall 4, 40 of each lug 1, 1a comprises a first front face 6 with base sides 6a, 6b. The base sides 6a, 6b have a transverse extension (or side to side) with respect to the sole.

The base sides 6a, 6b are parallel one with respect to the other but the top base side 6b (suitable to be in contact with the ground) is smaller than the bottom side base 6a (attached to the lower surface 20 of the sole). The base sides 6a, 6b are connected by two sides 6c (left), 6d (right) of the same size and opposite inclination, i.e. they are inclined towards the smaller base side 6b.

The front face 6 has therefore a trapezoidal shape.

Two main side faces 7 and 8 depart from the first front face 6, respectively on the left and on the right of the first front face 6.

Each main side face 7, 8 has the same shape, i.e. a trapezoidal shape.

Their extension is towards the bottom of the sole and respectively towards each side of the sole (the left main side face 7 is directed towards the outer side of the sole while the right main side face 8 is directed towards the inner side of the sole).

Each main side face 7, 8, has respectively base sides 7a, 7b, 8a, 8b parallel one with respect to the other with the top base sides 7b, 8b (suitable to be in contact with the ground) smaller than the bottom base sides 7a, 8a (attached to the lower surface 20 of the sole). The base sides 7a, 7b are connected by two sides 7c (left), 7d (right) of the same size and opposite inclination, i.e. they are inclined towards the smaller base side 7b. The side 7d coincides with the side 6c.

The base sides 8a, 8b are connected by two sides 8c (left), 8d (right) of the same size and opposite inclination, i.e. they are inclined towards the smaller base side 8b. The side 8c coincides with the side 6d.

Two minor side faces 9 and 10 depart respectively from the left main side face 7 and from the right main side face 8.

Each minor side face 9, 10 has the same shape, i.e. a trapezoidal shape.

Their extension is towards the bottom of the sole and towards each other. This means that the left minor side face 9 is oriented towards the right minor side face 10 and vice versa.

Each minor side face 9, 10, has respectively base sides 9a, 9b, 10a, 10b parallel one with respect to the other with the top base sides 9b, 10b (suitable to be in contact with the ground) smaller than the bottom base sides 9a, 10a (attached to the lower surface 20 of the sole). The base sides 9a, 9b are connected by two sides 9c (left), 9d (right) of the same size and opposite inclination, i.e. they are inclined towards the smaller base side 9b. The side 7c coincides with the side 9c. The base sides 10a, 10b are connected by two sides 10c (left), 10d (right) of the same size and opposite inclination, i.e. they are inclined towards the smaller base side 10b. The side 10d coincides with the side 8d.

At the end, to close or encircle the shape of the lug being disclosed, the sidewall 4 comprises two inner faces 11, 12.

The inner faces 11, 12 depart respectively from the left minor side face 9 and from the right minor side face 10. The inner faces 11, 12 are centrally connected the one with the other.

Each inner face 11, 12 has the same shape, i.e. a trapezoidal shape.

Their extension is towards the front of the sole and towards each other. This means that the left inner face 11 is oriented towards the right inner face 12 and vice versa.

Each inner face 11, 12, has respectively bases 11a, 11b, 12a, 12b parallel one with respect to the other with the top bases 11b, 12b (suitable to be in contact with the ground) smaller than the bottom bases 11a, 12a (attached to the lower surface 20 of the sole). The bases 11a, 11b are connected by one side 11c (left, coinciding with the side 9d) and one common side 13 (common to both inner faces 11, 12) of the same size and opposite inclination, i.e. they are inclined towards the smaller base 11b.

The bases 12a, 12b are connected by one right side 12d (right, coinciding with the side 10c) and the common side 13 of the same size and opposite inclination, i.e. they are inclined towards the smaller base 12b.

The sides 6b, 7b, 8b, 9b, 10b, 11b and 12b are connected by the first base 2 of the lug 1.

Obviously, the lug 1 can have different shapes and/or orientations, without departing from the scope of attached claims, as for example shown in FIGS. 13-15. The sidewall 4, 40 can be composed by front face 6, main side faces 7 and 8, minor faces 9, 10 and by inner faces 11 and 12.

Furthermore, with the overall shape of lug 1, 1a, already disclosed, the sidewall 4, 40 can be stepwise with steps 4a and/or with the lateral features or elements of the present invention.

For example, as shown in FIGS. 9A-9C, such configuration of the lug 1 comprises both indentations 4c and protrusions 4b, having features disclosed above. This specific version shows better results in terms of traction or grip.

If steps 4a are present, it is possible to alternate protrusions 4b on one step 4a and indentations 4c in another step 4a. Otherwise, protrusions 4b and indentations 4c may be present, in an alternating manner, also in the same step 4a.

The protrusions 4b and/or the indentations 4c constitute the lateral features or elements characterizing the present invention.

The present invention also refers to a sole equipped with a plurality of lugs 1, having the above-disclosed features.

In this way, it is seen that thanks to the present invention it is possible to obtain (small) faceting and/or features and/or elements in the sidewall 4 of the lug 1, thus obtaining a better traction and/or grip when compared with traditional lugs (such as the one of FIG. 1 or 2A). In fact, the presence of such features and/or elements increases significantly the surface are of the sidewall 4 (when compared to a smooth traditional lug 1a) thus giving a better traction.

The features and/or elements are three-dimensional structures which are placed or obtained at least at the sidewall 4 of the lug 1.

The features and/or elements can have any suitable geometrical solid shape, projecting from or creating corresponding voids in the lug structure.

The faces of the features and/or elements ca be, for example, in the shape of a hexagon, circle, square or rectangle, an oval shape, quadrangular or triangular, or a more complex shape. As far as the version of FIG. 16 is concerned, which can be an enlarged view of the lug of FIG. 11, a lug 1 according to a version of the invention is disclosed, where two types of protrusions 4b, different from one another, are present on at least part of the sidewall 4, 40. In fact, a stepwise structure is shown, but this version can be applied also to lugs with a smooth or not stepwise sidewall 40.

In particular, projections 4b of this version have two different shapes: a first shape 4b1 and a second shape 4b2. According to the shown example, the first shape 4b1 is a substantially semispherical shape or a faceted semi-sphere or a cubic or parallelepiped shape, while the second shape 4b2 is a pyramidal, frustum of pyramid, frustum of cone, or conical shape. In particular, the protrusions 4b2 have their vertex disposed towards the grounds.

Preferably, protrusions 4b1 are semispherical while protrusions 4b2 are pyramidal.

Each type of shapes 4b1, 4b2 can be arranged in linear arrangement, i.e. they are placed along a line parallel to the first base 2 and/or the second base 3 of the lug.

In particular, considering a direction starting from the second base 3 to the first base 2, it is possible to see that lines of protrusions 4b1 are parallel and alternating with respect to lines of protrusions 4b2.

Furthermore, when at least one step 4a is present, it is possible to have protrusions 4b1 placed on at least one vertical wall of the step 4a and protrusions 4b2 placed on at least one horizontal wall of the same step 4a.

According to a specific version, the step placed at the first base 2 has only one type of protrusions 4b1 or 4b2, preferably the protrusions 4b1, while the horizontal wall of such step, which corresponds to the first base 2, is free of protrusions.

In this way, the base 2 will remain smooth for contact with the ground, as the nearest protrusions 4b are those with the first shape 4b1, which is substantially semispherical shape or a faceted semi-sphere or a cubic or parallelepiped shape. In this case, as said, such protrusions of the first shape 4b1 are placed near the perimeter of the base 2 (along a first line L1 parallel to the base 2) but they do not protrude beyond the base, i.e. their height is completely contained in the total height of the lug 1.

However, in at least one version of the invention, for example shown in FIG. 18, the protrusions 4b having the second shape 4b2, i.e. those having a pyramidal, frustum of pyramid, frustum of cone, or conical shape, placed nearest the protrusions 4b1 of the first line L1 (i.e. those protrusions 4b2 placed along a second line L2, which is parallel to the base 2 and/or to the first line L1) can have a height that is smaller or equal to the distance between their base and the base 2 or a height that is higher than the distance between their base and the base 2. In such a latter case, the protrusions 4b2 can protrude beyond the base 2 and in this way, they are able to contact the ground.

In particular, according to at least one version of the invention, the protrusions 4b1 are placed in lines (to which the first line L1 belongs) which are parallel to the ground and in surfaces which have a direction vertical or substantially vertical, while the protrusions 4b2 are placed in lines (to which the second line L2 belongs) which are parallel to the ground and in surfaces which have a direction horizontal or substantially horizontal.

Therefore, the bases of the protrusions 4b1 are nearer to the base 2 than the bases of the protrusions 4b2.

When at least one step 4a is present, the base 2 is surrounded by a vertical surface where the protrusions 4b1 are placed. In contact with the vertical surface, there is a horizontal surface, that constitutes an angle of about 90° with the vertical surface, where the protrusions 4b2 are placed. Therefore, the height of the protrusions 4b2 can be smaller, equal or higher than the height of the vertical surface.

The same occurs when more than one step 4a is present.

Considering for example FIG. 17, it is clear that each protrusion 4b2 has below (considering the distance from the base 2 to the base 3) a protrusion 4b1.

Therefore, each protrusions 4b1 (for example of line L3 or L5) corresponds to a protrusion 4b2 placed at an immediate higher rank (for example respectively line L2 or L4) considering the proximity of the base 2 (which the exception of protrusions 4b1 of the first line L1, as said above).

Furthermore, if the sidewall 4, 40 is inclined towards the base 2, moving towards the base 2, the number of protrusions 4b in each line is reduced.

Obviously, the protrusions 4b, 4b1, 4b2 as disclosed can be applied only to one portion of the sidewall, or only to at least one face of the lug, according to the specific needs and/or conformation of the sole.

When the protrusions 4b2 are frustum of pyramid or pyramidal in shape, the base can have a triangular shape. In such a case, one side 51 of the triangular base (for example shown in FIG. 16) is placed parallel to the perimeter of the lug, considering the portion or face of the lug on which the specific protrusions 4b2 is placed. In particular, such side 51 of the triangular base is the outermost, in order to ideally follow the perimeter of the sidewall or of the step 4a.

In such a version, the outermost face 52 of the pyramid, corresponding to such side 51 of the triangular base, is triangular and, in at least one version of the invention, can have a vertical development, parallel for example to the vertical wall of a step 4a, is the step is present. In this way, the lug 1 creates a sort of vertical extended wall of the lug, created both by the vertical wall of the step and by the faces 52 of the protrusions 4b2, thus improving the grip properties of the lug itself.

Furthermore, lugs 1 are obtained in a single moulding step and, at least in one version of the invention, they are obtained in a single piece with the sole and/or its lower surface 20. This means that such lugs are realized at the same time with the sole and directly attached to the sole (or better to the lower surface 20 thereof).

Furthermore, the present invention refers also to a method for obtaining a mold, with which it is possible to mould the sole and/or lugs of the present invention. FIG. 21 depicts an exemplary method for obtaining a mold for the production of a sole according to an embodiment of the present invention.

In particular, first of all in step 2101, it is possible to determine (for example by the creation of a digital file) the bidimensional (2D) structure or pattern desired for a specific sole and/or lug (see for example FIG. 9D). That is, this step determines a 2D structure/pattern which corresponds to the shape of the sole with lugs.

As an optional step (step 2103), the 2D structure or pattern can comprise, if desired, also the position and shape of at least one logo and/or trademark, as those indicated with reference 30.

After that, a three-dimensional 3D digital file is created corresponding to the 2D structure/pattern (step 2105) and therefore corresponding to the sole with lugs, as shown in FIGS. 10, 11 and 12. Such 3D file shows the amount of space occupied by the at least one lug 1, comprising its shape and sidewall 4, 40, together with possible steps 4a, protrusions 4b and/or indentations 4c. As shown in such figures and their corresponding descriptions in the present application, the protrusions 4b can have also a pyramidal shape, or any one of the previously described shapes, dimensions and conformations.

After that, from the 3D digital file, at least one 3D printed model is obtained (which can e.g., be a sand model) via printing step using a 3D printing machine (step 2107). This 3D printed model corresponds to a shape of the sole and lugs (and possible removal of parts not connected with the 3D printed model and therefore with the 2D structure/pattern, to obtain a precise shape of the sole with lugs): this is the ‘3D printed model’.

Namely, after the printing step, it follows a step 2109 of cleaning parts (not related to the final shape of the solidified 3D printed model) to obtain said 3D printed model.

After the cleaning step, it follows a step of cast pouring the material, for example a molten metal, for the mold, and solidifying such material (step 2111) to obtain a solidified metal mold. Thereafter, the parts of the solidified 3D printed model are removed (step 2113) from the solidified metal mold after the solidification of the molten metal. The solidified metal mold is cleaned, and it is ready for being used for obtaining the sole and/or the lugs.

That is, e.g., when the metal mold is solidified, the parts of the 3D printed model are removed, in order to obtain a free shape corresponding to the shape of the removed 3D printed model, and therefore of the sole with lugs: this is the ‘casting mold’. Particularly, the solidified 3D printed model has a complementary shape with respect to that of the mold, which in turn will have a complementary shape with respect to the sole and/or the lugs.

According to one exemplary embodiment, molten metal is poured (e.g., around the 3D printed model) in order to obtain-when the metal is solidified - such a metal mold for the sole with lugs. Thus, by using 3D printed models it is possible to obtain a mold (for example a solidified metallic mold) for the sole and/or lugs of the present invention. Overall, a process for printing casting molds, as said, begins with a digital file, going then through solidification, printing and finally casting the metallic mold.

The printing step can be performed via 3D printing by a 3D laser printing machine, as a not-limiting example of the invention.

For example, when a mold produced according to the steps of FIG. 21 is ready, such sole and/or lugs, in at least one version of the invention, can be obtained by pouring on the solidified metal mold a material suitable for obtaining a sole and/or a lug, i.e. an elastomeric or a plastic or polymeric or rubber material, possibly comprising further components in order to still further improve the features of the sole and/or of the lug, and solidifying such material in order to obtain the sole and/or the lugs 1.

In particular, by using the 3D printed models according to the present invention it is possible to obtain the features and/or elements (that are undercuts and/or protrusions of small size on the sides and/or top base of the lug) on the sides of the lug 1, which give an improved traction or grip to the sole itself.

### EXAMPLES OF THE PRESENT INVENTION

Below is an example showing the increase in surface area of the sides of the lug 1 considering its several versions:
Original side wall area/lug =274 mm² (FIG. 1);
Stepwise side wall area/lug =455 mm² (FIG. 2A);
Features side wall area/lug =637 mm² (FIG. 9A). In this case, it is possible to obtain a 57% increase in the side wall area/lug, varying the patters of its sidewall 4.
Spherical side wall area/lug=about 63 mm²;
Triangular and/or pyramidal or frustum of pyramid side wall area/lug=about 119 mm².

Obviously the above numbers depend on lug design, geometry, lug size, sidewall features, feature frequency and scale.

For example, the spherical side wall area refers to the surface area contributed by all the hemispheres on one of the lugs of FIG. 9A. The triangular side wall area is the surface area measurement of all the spike features or indentations on FIG. 9A.

In the present specification the word “lug” means any projection from the sole of a shoe or boot to improve traction or grip strength with the ground.

According to one version of the invention, the sole and the at least one lug 1 have an overall thickness of 0.8 cm to 1.2 cm. The thickness of the sole can be of 2 to 4 mm.

The lug 1 protrudes from the lower surface 20 of the sole of a height of 0.4 to 1.0 cm, in particular of 0.6 cm.

The overall width of one lug 1 can be comprised between 1.2 and 2.0 cm, in particular it is 1.4 or 1.5 cm.

The horizontal size of the at least one step 4 a can be 1.0 to 1.3 mm; the vertical size of the at least one step 4 a can be 1.0 to 2.0 mm.

The size of the at least one protrusion 4b, i.e. the measure of how much it protrudes, can be 0.4 to 0.8 mm.

The size of the at least one indentation 4c, i.e. the measure of how much it penetrates inside the lug. Can be 0.4 to 2.0 mm.

The difference between the fist base 2 and the second base 3 of the lug 1 can be 1.0 to 2.0 mm each side, in particular 1.5 mm each side.

Obviously, different dimensions or sizes are possible, without departing from the scope of the invention.

It is thus seen that the sole and/or lugs according to the present invention determine an effective solution to the need of producing a sole for footwear, or in particular an outsole, able to respond to the above needs, while allowing an improved traction during the performance of athletic activity, for example walking, running or others, for which they are foreseen.

The invention described above is susceptible to numerous modifications and variations within the protection of the following claims.

1. A lug for a sole or outsole of a footwear, for example shoe, a sport shoe or a work footwear or a boot, wherein said lug comprises a first base, a second base and a sidewall, wherein said first base is suitable to contact the ground during use, said second base is suitable to be attached to the sole or outsole and/or it is opposite to said first base and said sidewall is suitable to connect laterally said first base and said second base, wherein said lug comprises features and/or elements at least at a part of said sidewall able to confer to said lug traction and grip on grounds or terrains consisting of granular particulates or penetrable surfaces, wherein said features and/or elements comprise at least one protrusion wherein said lug comprises protrusions of a first shape and of a second shape, wherein the first shape is different than the second shape.

2. The lug according to claim 1, wherein the first shape is a substantially semispherical shape or a faceted semi-sphere or a cubic or parallelepiped shape, while the second shape is a pyramidal, frustum of pyramid, frustum of cone, or conical shape, with their vertex disposed in use towards the grounds, or preferably wherein said protrusions are semispherical while said protrusions are pyramidal.

3. The lug according to claim 1, wherein each of said types of shapes is arranged in linear arrangement, i.e. they are placed along a line parallel to the first base and/or the second base of said lug, and/or wherein lines of said protrusions are parallel and alternating with respect to lines of said protrusions.

4. The lug according to claim 1, wherein said features and/or elements increase the surface area of said sidewall and/or wherein said features and/or elements are present at said first base of said lug and increase the surface area of said first base.

5. The lug according to claim 1, wherein said sidewall comprises at least one step or wherein said sidewall is not stepwise or has not a step or is smooth.

6. The lug according to claim 1, wherein said lug has a substantially prismatic, cubic or parallelepiped conformation, with said first base and said second base shaped substantially as a rectangle, a square, a trapezoid, hexagon.

7. The lug according to claim 1, wherein said lug has a V-like shape in top plan view and said first base and said second base have a V-like shape in top plan view or wherein said lug has a substantially cylindrical, hemispherical, tetrahedral, semi-ellipsoidal, frustum of cone or frustum of pyramid, regular, irregular, L-like, C-like shape, and said first base and second base have a square, rectangular, polygonal, parallelogram, regular, irregular, L-like, C-like or trapezoidal shape.

8. The lug according to claim 1, wherein said first base is smaller in size than said second base and said sidewall is inclined and/or tapered in use towards a common point of the ground and/or wherein said sidewall comprises faces inclined in use towards a common point of the ground and/or wherein said first base is parallel or not parallel with respect to said second base.

9. The lug according to claim 1, wherein said first base and said second base have the same size, and they are substantially superimposed the one with the other, whereby said sidewall is substantially perpendicular to said first base and/or to said second base.

10. The lug according to claim 1, wherein said first base and said second base have the same size, but they are offset one with respect to the other and said sidewall is inclined in use towards the ground along a same direction and/or wherein said sidewall comprises faces inclined in use towards the ground along a same direction.

11. The lug according to claim 1, wherein said at least one step has sharp or rounded edges and/or it has right-angled edges and/or wherein each step, when more than one step is present, has substantially the same size.

12. The lug according to claim 1, wherein, when at least one step is present, said protrusions of the first shape are placed on at least one vertical wall of the step and said protrusions of the second shape placed on at least one horizontal wall of the same step.

13. The lug according to claim 1, wherein said step placed at the first base has only one type of protrusions of the first shape or of the second shape, wherein protrusions of the first shape are along a first line (L1), while the horizontal wall of said step, which corresponds to said first base, is free of protrusions.

14. The lug according to claim 13, wherein said protrusions having the second shape which are placed nearest the protrusions of the first shape of the first line (L1) are placed along a second line (L2), which is parallel to the base and/or to the first line (L1) and they have a height that is smaller or equal to the distance between their base and the base or a height that is higher than the distance between their base and the base, in the latter case, the protrusions protruding beyond the base and being able to contact the ground during use.

15. The lug according to claim 1, wherein said protrusions of the first shape are placed in lines which are parallel to the ground and in surfaces which have a direction vertical or substantially vertical, while said protrusions of the second shape are placed in lines which are parallel to the ground and in surfaces which have a direction horizontal or substantially horizontal.

16. The lug according to claim 1, wherein said at least one protrusion comprises a protruding shape and a base, wherein said base is attached to said sidewall and/or to said step and said protruding shape is a substantially semispherical shape or a faceted semi-sphere, or a cubic or parallelepiped shape, or pyramidal, frustum of pyramid, frustum of cone, conical, and/or with a square, rectangular, polygonal, parallelogram, regular, irregular, L-like shaped, C-like shaped, or trapezoidal base.

17. The lug according to claim 1, wherein said sidewall comprises trapezoidal shaped faces, wherein said sidewall comprises a first front face with base sides parallel one with respect to the other and sides connecting laterally said base sides and inclined towards said base side which in use is top and smaller than said side base, two main side faces departing from said first front face respectively towards the bottom of the sole on the left and on the right of said first front face, with respectively base sides parallel one with respect to the other, sides connecting laterally said base sides and inclined towards said base side which in use is top and smaller than said side base, and sides connecting laterally said base sides and inclined towards said base side which in use is top and smaller than said side base, two minor side faces departing respectively towards the bottom of the sole from said main side face and from said main side face, with base sides parallel one with respect to the other, two sides (connecting laterally said base sides and inclined towards said base side which in use is top and smaller than said side base, and two sides connecting laterally said base sides and inclined towards said base side which in use is top and smaller than said side base, and two inner faces departing respectively from said minor side face and from said minor side face in use towards the front of the sole, wherein said inner faces are centrally connected the one with the other, with base sides parallel one with respect to the other, one side and one common side connecting said base sides and inclined towards the base side which in use is top and smaller than said side base, one side connecting together with said common side said base sides and inclined towards the base side which in use is top and smaller than said side base, and wherein said sides are connected by said first base of the lug.

18. Sole of a footwear, wherein said sole comprises an upper surface, adapted in use to face toward the foot of a user, and a lower surface, adapted in use to face toward the resting surface or the ground, wherein said lower surface comprises at least one and/or a plurality of lugs according to claim 1.

19. The sole according to claim 18, wherein said lower surface is directly attached, by means of a unique molding step, with said at least one lug and/or said plurality of lugs, for example at said second base of said lug.

20. The sole according to claim 18, wherein said lower surface comprises at least one protrusion and/or at least one indentation.

21. A method for obtaining a mold for the production of a sole, comprising the following steps:
determining, by creating a digital file, a bi-dimensional (2D) structure or pattern desired for a sole, wherein said bi-dimensional (2D) structure or pattern comprises at least one lug according to claim 1,
indicating in said bi-dimensional (2D) structure or pattern the position and shape of at least one logo and/or trademark,
determining a three-dimensional (3D) digital file corresponding to said bi-dimensional (2D) structure or pattern,
printing at least one 3D printed model by a 3D printing machine, wherein said 3D printed model is provided in a shape substantially corresponding to a structure complementary to said mold for the production of a sole,
cast pouring a molten metal around the 3D printed model and solidifying the molten metal, in order to obtain a solidified metal mold, and
after the steps of casting and solidifying, removing the parts of the solidified 3D printed model from the solidified metal mold to obtain a casting mold.

22. A method for obtaining a sole, comprising the following steps:
providing the mold according to claim 21,
pouring in said mold a material for said sole,
solidifying said material for said sole and obtain said sole equipped with at least one lug and/or a plurality of lugs.
